(19) United States
(12) Patent Application Publication
(10) Pub. No.: US 2026/0027810 A1
(43) Pub. Date: Jan. 29, 2026

(54) BORON NITRIDE NANOSHEETS REINFORCED COMPOSITE MATERIAL AND METHOD FOR PRODUCING THE SAME

(71) Applicant: KOREA INSTITUTE OF SCIENCE AND TECHNOLOGY, Seoul (KR)

(72) Inventors: Jaesang YU, Wanju-gun (KR); Yuna Oh, Wanju-gun (KR); Kwak Jin Bae, Wanju-gun (KR); Kyoungmin Park, Wanju-gun (KR)

(21) Appl. No.: 18/960,643

(22) Filed: Nov. 26, 2024

(30) Foreign Application Priority Data
Jul. 24, 2024 (KR) 10-2024-0098153

(51) Int. Cl. B32B 18/00; B32B 5/16; B32B 27/14; B32B 27/28; B32B 37/06; B32B 37/08; B32B 37/10

(52) U.S. Cl. CPC B32B 18/00; B32B 5/16; B32B 27/14; B32B 27/288; B32B 37/06; B32B 37/08; B32B 37/10; B32B 2250/05; B32B 2264/10; B32B 2307/302; B32B 2307/51; B32B 2307/54

(57) ABSTRACT

The present disclosure relates to a boron nitride nanosheet-reinforced composite material having excellent thermal and mechanical properties and a method for producing the same. The boron nitride nanosheet-reinforced composite material has a multilayer structure, which is an ideal structure for improving thermal conductivity in a plane direction, and can enhance an elastic modulus and maintain a tensile strength by the multilayer structure of a polymer and a filler.

### DESCRIPTION OF GOVERNMENT-SPONSORED RESEARCH AND DEVELOPMENT

This research was conducted with the support of the Ministry of Science and ICT of the Republic of Korea under the supervision of the Korea Institute of Science and Technology. The research business name is the Korea Institute of Science and Technology's Research Operation Expense Support (Main business Expense), and the research project name is the Jeonbuk Branch Operation Project (Development of Completely Resource-Circulating Composite Material Technology for Application of Next-Generation Composite Material Components) (Project Identification Number: 1711196536).

This research was conducted with the support of the Ministry of Trade, Industry and Energy of the Republic of Korea under the supervision of the Korea Planning and Evaluation Institute of Industrial Technology. The research business name is the Development of Material and Component Technology, and the research project name is the Development of Ultra-Light 19-inch Carbon Composite Wheels Using Integrated Braid Preform Manufacturing Technology with Tow Prepreg Material (Project Identification Number: 1415186326).

### CROSS REFERENCE TO RELATED APPLICATION

The present application claims the priority of Korean Patent Application No. 10-2024-0098153 filed on Jul. 24, 2024, the entire content of which is incorporated herein for all purposes by this reference.

### BACKGROUND OF THE INVENTION

### Field of the Invention

The present disclosure relates to a boron nitride nanosheet-reinforced composite material having excellent thermal and mechanical properties and a method for producing the same, and is also directed to a composite material capable of maintaining light weight, specific strength, and specific rigidity while simultaneously having electrical insulation property and thermal conductive property. Such a composite material has excellent thermal conductive property and electrical insulation property so that it can be applied to a semiconductor package, a heat dissipation pad, a display, etc.

### Description of the Related Art

In general, a semiconductor such as a computer (CPU), a transistor, and a light-emitting diode (LED) generates heat during use, and the performance of electronic components may deteriorate due to the heat. Therefore, a heat sink is mounted on the electronic components that generate heat.

Since the heat sink is often made of metal, research has been continuously conducted on a method of increasing adhesion by inserting a thermally conductive composition in the form of a sheet or gel so as to improve the adhesion between the CPU and the heat sink.

However, the polymers commercially used in the existing semiconductor packages, displays, etc., are light, but have low thermal conductivity, which often adversely affects the lifespan of the device. Therefore, it is required to develop composite materials with improved heat dissipation performance by adding nanofillers with high thermal conductivity and electrical insulation property to polymers.

### SUMMARY OF THE INVENTION

According to an embodiment, the present disclosure is to provide a nanosheet-reinforced composite material that efficiently improves thermal property and maintains specific strength and specific rigidity with a relatively low content of a filler.

According to an embodiment, the present disclosure is to provide a simple and effective method for producing and forming a multilayer structure.

As an exemplary embodiment, the present disclosure provides a nanosheet-reinforced composite material comprising: a film layer containing a polyketone-based polymer; and a filler layer containing boron nitride,
wherein the film layer and the filler layer are repeatedly laminated on each other.

In an embodiment, the film layer may be laminated with 1 to 10 films containing the polyketone-based polymer.

In an embodiment, a content of the boron nitride may be 1 to 20 wt % based on the total weight of the nanosheet-reinforced composite material.

In an embodiment, the nanosheet-reinforced composite material may be pressurized and heated.

In an embodiment, the boron nitride in the filler layer may be arranged in a plane direction.

In an embodiment, thermal conductivity of the nanosheet-reinforced composite material in a thickness direction may be 0.26 W/mK or more.

In an embodiment, thermal conductivity of the nanosheet-reinforced composite material in a plane direction may be 0.27 W/mK or more.

In an embodiment, a tensile strength of the nanosheet-reinforced composite material may be 100 MPa or more.

In an embodiment, a tensile elastic modulus of the nanosheet-reinforced composite material may be 4.3 GPa or more.

In an embodiment, the boron nitride may be a powder having a particle size of 10 to 45 microns.

As another exemplary embodiment, the present disclosure provides a method for producing a nanosheet-reinforced composite material, the method comprising the steps of:
preparing a film containing a polyketone-based polymer;
forming a filler layer by applying boron nitride on the film containing the polyketone-based polymer; and
obtaining a sheet consisting of multiple layers by repeating the above steps.

In an embodiment, the step of preparing the film may include laminating 1 to 10 films containing the polyketone-based polymer.

In an embodiment, the boron nitride may be in the form of a powder.

In an embodiment, the boron nitride may be a powder having a particle size of 10 to 45 microns.

In an embodiment, a content of the boron nitride may be 1 to 20 wt % based on the total weight of the nanosheet-reinforced composite material.

In an embodiment, the above method may further comprise the step of pressurizing and heating the sheet.

In an embodiment, the pressurizing may be performed at 5 to 15 MPa.

In an embodiment, the heating may be performed at 350 to 450° C.

In an embodiment, the above method may further comprise the step of cooling the sheet after the pressurizing and heating.

In an embodiment, the cooling may be performed at 200 to 300° C.

A nanosheet-reinforced composite material according to an embodiment of the present disclosure has an ideal structure of the multilayer structure composite material for improving thermal conductivity, and can efficiently enhance the thermal conductivity by forming a heat transfer path in a plane direction, and can enhance an elastic modulus as well as maintain a tensile strength by the multilayer structure of the polymer and the filler.

### BRIEF DESCRIPTION OF THE DRAWINGS

FIG. 1 is a view schematically showing a nanosheet-reinforced composite material and a method for producing the same according to an embodiment of the present disclosure.

FIGS. 2 and 3 are results obtained by observing the arrangement of a nanosheet-reinforced composite material in a filler layer, which was produced according to an embodiment of the present disclosure.

FIG. 4 is a result obtained by observing the tensile properties of a nanosheet-reinforced composite material produced according to an embodiment of the present disclosure.

FIG. 5 is a result obtained by observing the thermal conductive properties of a nanosheet-reinforced composite material produced according to an embodiment of the present disclosure.

FIG. 6 is a result obtained by observing the thermal conductive properties of a nanosheet-reinforced composite material in a plane direction, which was produced according to an embodiment of the present disclosure.

### DETAILED DESCRIPTION OF THE INVENTION

Hereinafter, preferred embodiments of the present disclosure will be described in detail with reference to the attached drawings.

The embodiments of the present disclosure disclosed in this specification are merely exemplified for the purpose of explanation. Since the embodiments of the present disclosure may be implemented in various forms, they should not be construed to be limited to the embodiments described in this specification.

The present disclosure may have various modifications and various types. Accordingly, the embodiments are not intended to limit the present disclosure to a specific disclosure form, but should be understood to cover all modifications, equivalents, or substitutes included in the spirit and technical scope of the present disclosure.

In this specification, in case a certain part is mentioned to “include” a certain component, this means that it may further include other components, rather than excluding other components, unless otherwise specifically stated.

Hereinafter, exemplary embodiments of the present disclosure will be described in detail.

As an exemplary embodiment, the present disclosure provides a nanosheet-reinforced composite material comprising: a film layer containing a polyketone-based polymer; and a filler layer containing boron nitride,
wherein the film layer and the filler layer are repeatedly laminated on each other.

For example, the polyketone-based polymer may be at least one selected from the group consisting of polyether ether ketone (PEEK), polyether ketone (PEK), polyaryl ether ketone (PAEK), polyether ketone ketone (PEKK), and polyether ketone ether ketone ketone (PEKEKK).

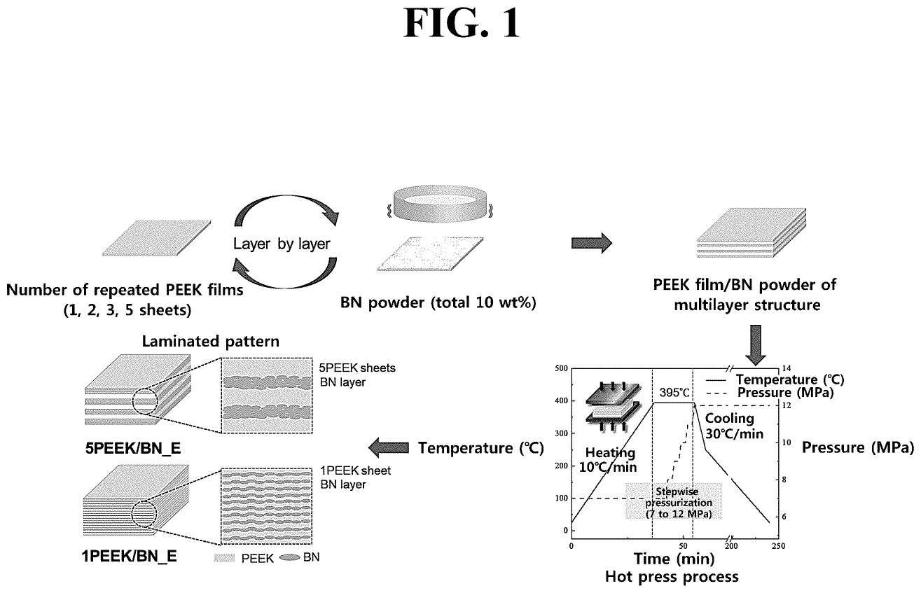

Referring to FIG. 1, according to an exemplary embodiment of the present disclosure, the film layer containing the polyketone-based polymer, for example, the PEEK film layer containing polyether ether ketone, and the filler layer containing boron nitride can be repeatedly laminated in a plurality of layers without surface modification of boron nitride, thereby improving thermal conductivity through structural control of the composite material.

The polyether ether ketone belongs to the polyketone series of a semi-crystalline thermoplastic resin and can be used as parts and accessories of semiconductor process equipment. The polyether ether ketone is an ideal material for manufacturing a semiconductor device due to its high temperature stability and chemical stability, and can be used in the form of a film according to an exemplary embodiment of the present disclosure.

The boron nitride (BN) is a material having a planar structure and has characteristics such as piezoelectric property, transparency, high thermal conductivity, and chemical resistance so that it has potential for use as a sensor element of a device, etc. In addition, the boron nitride is a material that has electrical insulation property. For example, the boron nitride may be hexagonal boron nitride (h-BN) in a 2D form and may be an XGP product from Denka.

In an embodiment, the film layer may be laminated with 1 to 10 films containing the polyketone-based polymer.

For example, the PEEK film may be laminated one by one and the boron nitride filler layer may be formed on each film, or each of the two or more PEEK films may be laminated and the boron nitride filler layer may be formed on an upper surface where the multiple PEEK films are laminated.

For example, the film layer may be formed by laminating 1 or more, 2 or more, 3 or more, 4 or more, 5 or more, 6 or more, 7 or more, 8 or more, or 9 or more films containing the polyketone-based polymer, and may be formed by laminating 10 or less, 9 or less, 8 or less, 7 or less, 6 or less, 5 or less, 4 or less, 3 or less, or 2 or less films containing the polyketone-based polymer.

In an embodiment, a content of the boron nitride may be 1 to 20 wt % based on the total weight of the nanosheet-reinforced composite material.

For example, the content of the boron nitride may be 1 wt % or more, 5 wt % or more, 10 wt % or more, or 15 wt % or more, based on the total weight of the nanosheet-reinforced composite material, and may be 20 wt % or less, 15 wt % or less, 10 wt % or less, or 5 wt % or less, based on the total weight of the nanosheet-reinforced composite material.

If the content of the boron nitride is less than 1 wt %, the content of the boron nitride is relatively small compared to the weight of the PEEK, so that the thermal conductivity in a plane direction may be reduced due to the inability to form a heat transfer path, and if it exceeds 20 wt %, internal pores may be generated, which may deteriorate the mechanical properties.

In an embodiment, the nanosheet-reinforced composite material may be pressurized and heated.

In an embodiment, the boron nitride in the filler layer may be arranged in a plane direction.

For example, the I₀₀₂/I₁₀₀ value of the nanosheet-reinforced composite material may be 220 or more, and may be, for example, 220 or more, 225 or more, 230 or more, or 235 or more.

According to an embodiment of the present disclosure, the orientation of the boron nitride filler may be induced in the plane direction only by pressurizing and heating means such as hot press without using a magnetic field.

In an embodiment, the thermal conductivity of the nanosheet-reinforced composite material in a thickness direction may be 0.26 W/mK or more.

In an embodiment, the thermal conductivity of the nanosheet-reinforced composite material in a plane direction may be 0.27 W/mK or more.

In an embodiment, a tensile strength of the nanosheet-reinforced composite material may be 100 MPa or more.

In an embodiment, a tensile elastic modulus of the nanosheet-reinforced composite material may be 4.3 GPa or more.

In an embodiment, the boron nitride may be a powder having a particle size of 10 to 45 microns.

As another exemplary embodiment, the present disclosure provides a method for producing a nanosheet-reinforced composite material, the method comprising the steps of:
preparing a film containing a polyketone-based polymer;
forming a filler layer by applying boron nitride on the film containing the polyketone-based polymer; and
obtaining a sheet consisting of multiple layers by repeating the above steps.

In an embodiment, the step of preparing the film may include laminating 1 to 10 films containing the polyketone-based polymer.

For example, the film layer may be laminated with 1 or more, 2 or more, 3 or more, 4 or more, 5 or more, 6 or more, 7 or more, 8 or more, or 9 or more films containing the polyketone-based polymer, and may be laminated with 10 or less, 9 or less, 8 or less, 7 or less, 6 or less, 5 or less, 4 or less, 3 or less, or 2 or less films containing the polyketone-based polymer.

In an embodiment, the boron nitride may be in the form of a powder.

In an embodiment, the boron nitride may be a powder having a particle size of 10 to 45 microns.

In an embodiment, a content of the boron nitride may be 1 to 20 wt % based on the total weight of the nanosheet-reinforced composite material.

For example, the content of the boron nitride may be 1 wt % or more, 5 wt % or more, 10 wt % or more, or 15 wt % or more, based on the total weight of the nanosheet-reinforced composite material, and may be 20 wt % or less, 15 wt % or less, 10 wt % or less, or 5 wt % or less, based on the total weight of the nanosheet-reinforced composite material.

In an embodiment, the above method may further comprise the step of pressurizing and heating the sheet.

In an embodiment, the step of pressurizing and heating the sheet may include a process by hot press, autoclave (AC), oven molding (semi prepreg, Resin Film Infusion), filament winding (FW), resin transfer molding (RTM), vacuum assisted RTM (VaRTM), prepreg compression molding (PCM), or injection molding. For example, the step may be performed through a process by the hot press.

In an embodiment, the pressurizing may be performed at 5 to 15 MPa.

For example, the pressurizing may be performed at 5 MPa or more, 9 MPa or more, or 13 MPa or more, and may be performed at 15 MPa or less, 11 MPa or less, or 7 MPa or less.

For example, the pressurizing may be performed stepwise at 7 to 12 MPa. If the pressure exceeds 12 MPa, thicknesses of the PEEK layer and the BN layer (layer sprayed with boron nitride) may be decreased, which may lead to a deterioration in thermal conductivity and tensile strength.

For example, the pressurizing may be performed by stepwise pressurizing from 7 MPa to 12 MPa by each 1 MPa for 3 minutes, respectively.

In an embodiment, the heating may be performed at 350 to 450° C.

For example, since thermal decomposition of the PEEK occurs if the heating temperature exceeds 550° C., the heating may be performed at a temperature lower than 550° C.

For example, the heating may be performed at 350° C. or higher, 390° C. or higher, or 430° C. or higher, and may be performed at 450° C. or lower, 410° C. or lower, or 370° C. or lower.

For example, the heating may be performed up to 395° C. at a rate of 10° C./min.

In an embodiment, the above method may further comprise the step of cooling the sheet after the pressurizing and heating.

In an embodiment, the cooling may be performed at 200 to 300° C.

For example, the cooling may be performed at a temperature of 200° C. or higher, 240° C. or higher, or 290° C. or higher, and may be performed at a temperature of 300° C. or lower, 260° C. or lower, or 220° C. or lower.

For example, the cooling may be performed up to 250° C. at a rate of 30° C./min, and then, after reaching 250° C., the cooling may be gradually performed up to a room temperature by slow cooling.

The present disclosure is described through the following Examples in more detail. However, since the Examples are intended to illustrate the present disclosure, the scope of the present disclosure is not limited only by these Examples.

### EXAMPLES

As shown in FIG. 1, a polyether ether ketone (PEEK) film and a boron nitride (BN) filler are repeatedly laminated. In this case, the number of laminated polymer films repeated for each sample is set to 1, 2, 3, and 5. The BN is sprayed on surfaces of the repeated PEEK films, wherein a total amount of the BN is adjusted to 10 wt % based on the weight of the entire composite material. The amount sprayed on each of the BN layers in one composite material is the same for each BN layer.

The laminated PEEK film/BN powder are pressurized by a hot press to produce a multilayer structure composite material (see FIG. 1). The laminated PEEK film/BN powder are heated up to 395° C. at a rate of 10° C. per minute, wherein the pressure is set to 7 MPa. If the laminated PEEK film/BN powder reach 395° C., the pressurizing is preformed by stepwise pressurizing from 7 MPa to 12 MPa by each 1 MPa for 3 minutes, respectively. After that, the laminated PEEK film/BN powder are cooled up to 250° C. by water cooling at a rate of 30° C. per minute while maintaining the pressure of 12 MPa. If the laminated PEEK film/BN powder reach 250° C., they are cooled up to a room temperature by slow cooling.

The produced composite material is named XPEEK/BN_E, wherein X represents the number of repeated PEEK films.

### EXPERIMENTAL EXAMPLES

### Experimental Example 1—Filler Arrangement

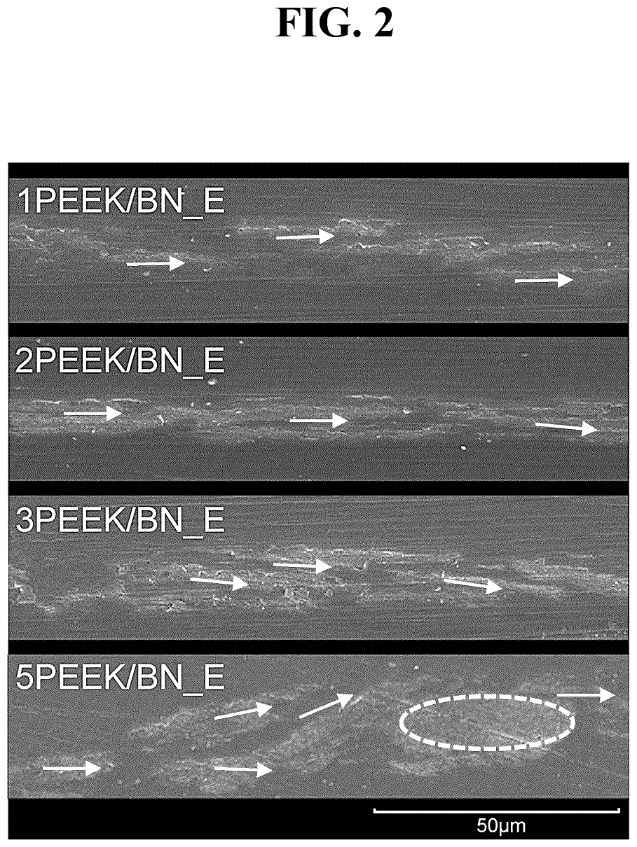

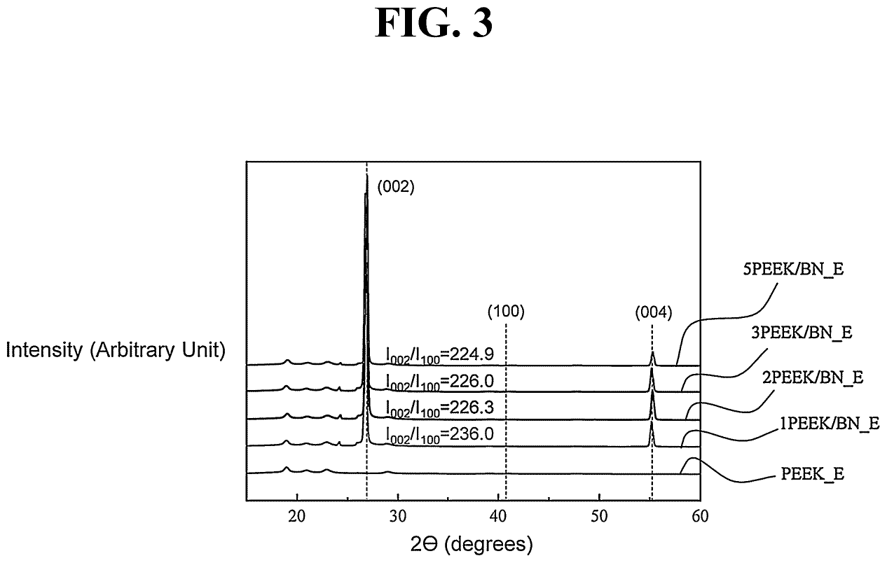

As shown in FIGS. 2 and 3, the filler arrangement characteristics of the nanosheet-reinforced composite materials produced by Examples were observed.

In case of the 1PEEK/BN composite material, due to the frequent lamination of the PEEK film and the BN layer, the BN was well arranged in the plane direction by transferring the pressure evenly during the hot press process. (FIG. 2)

However, in case of the 5PEEK/BN composite material, due to the BN localized in one BN layer, the BN arrangement was disturbed by transferring the pressure unevenly during the hot press. (FIG. 2)

It can be seen from the X-ray diffraction results that the 1PEEK/BN composite material having the thinnest PEEK and BN layers had the highest 1002/1100 value, indicating that the BN was well arranged in the plane direction. (FIG. 3)

### Experimental Example 2—Tensile Characteristics

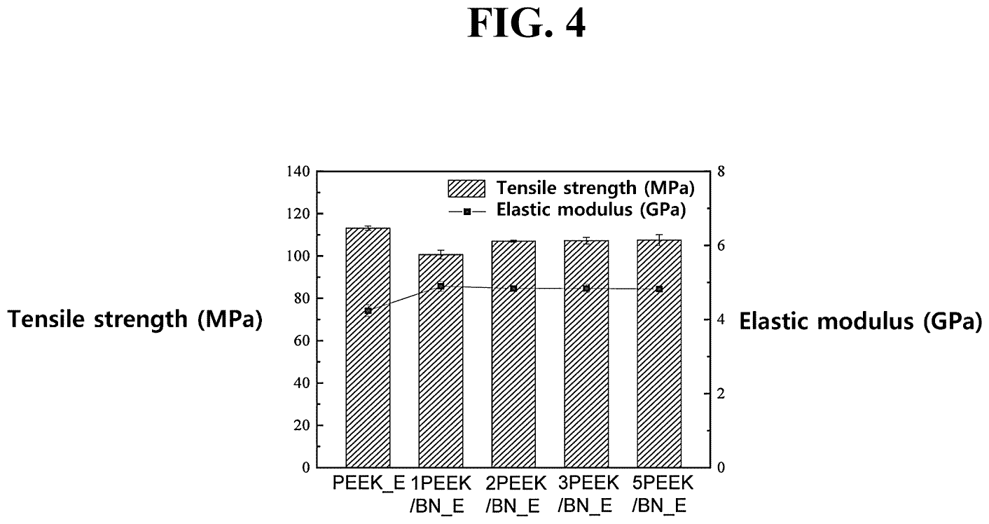

As shown in FIG. 4 and Table 1 below, the tensile characteristics of the nanosheet-reinforced composite materials produced by Examples were observed. Specifically, tensile specimens were manufactured according to ASTM D638 standard, and an Instron 5985 universal material testing machine from Instron was used, and the test was performed at a rate of 1 mm/min.

It was confirmed that, when the BN was added to the PEEK, the elastic modulus of the PEEK/BN composite material was enhanced by approximately 15%, and the PEEK/BN composite material maintained the tensile strength of the PEEK as the thickness of the PEEK layer increased. In other words, as the thickness of the PEEK layer in the composite material increases, the tensile strength value of the PEEK which has not been composited can be maintained. In case of the 1PEEK, since the PEEK layer was thin, the tensile strength was lower than that of the PEEK which has not been composited.

TABLE 1

| | Tensile strength | Tensile elastic |
|---|---|---|
| Sample | (MPa) | modulus (GPa) |
| Comparative Example | 113.18 | 4.24 |
| 1 (PEEK) | | |
| Example 1 (1PEEK/BN) | 100.66 | 4.90 |
| Example 2 (2PEEK/BN) | 107.02 | 4.84 |
| Example 3 (3PEEK/BN) | 107.29 | 4.84 |
| Example 4 (5PEEK/BN) | 107.48 | 4.83 |

### Experimental Example 3—Thermal Conductivity Characteristics 1

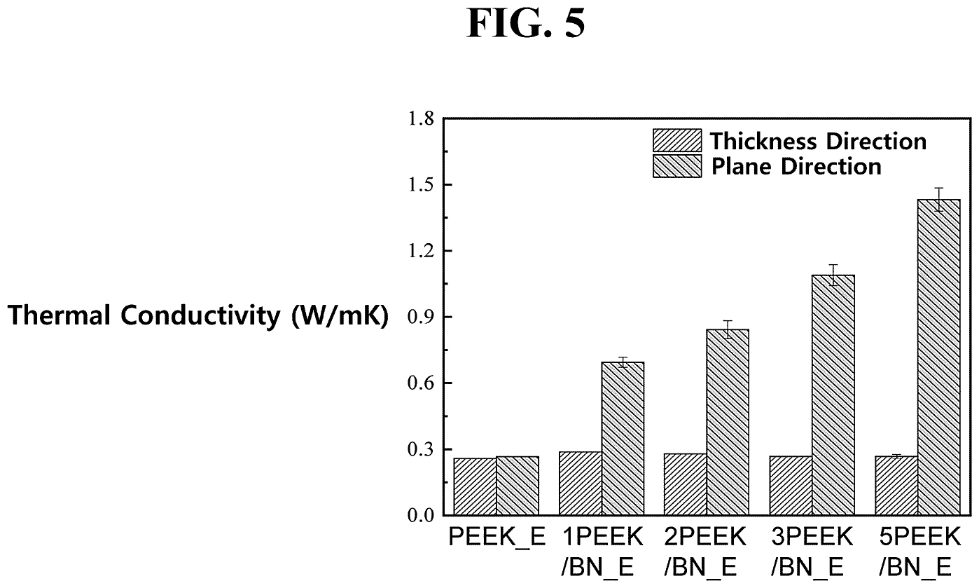

As shown in FIG. 5 and Table 2 below, the thermal conductivity characteristics of the nanosheet-reinforced composite materials produced by Examples were observed. Specifically, the LFA467 equipment from Netzsch, which satisfies ASTM E1461 standard, was used. A holder of 12.7 mm diameter was used to measure the thermal conductivity in a thickness direction, and a square holder of 10 mm in length and width was used to measure the thermal conductivity in a plane direction.

The thermal conductivities of the 1, 2, 3, and 5PEEK/BN composite materials were confirmed to be 0.267, 0.694, 0.842, 1.090, and 1.432 W/mK, respectively. In particular, it was confirmed that the thermal conductivity of the 5PEEK/BN composite material was improved by approximately 437% compared to the PEEK, and that the 5PEEK specimen had excellent thermal conductivity because it had a thick filler layer per layer formed by gathering a number of the fillers.

The PEEK/BN composite material showed a remarkable improvement in the thermal conductivity of the plane direction as the thicknesses of the PEEK and BN layers increased.

On the other hand, the 1PEEK/BN composite material in which the BN was relatively well dispersed had the highest thermal conductivity in the thickness direction, which was improved by approximately 15% compared to the PEEK.

That is, with respect to the thermal conductivity in the thickness direction, the 1PEEK having a thin filler layer is slightly higher than the PEEK, because the 1PEEK has a narrow gap between the BN layer and the BN layer to form a slight heat transfer path. However, the thermal conductivity of the 2,3,5PEEK is similar to that of the PEEK because the 2,3,5PEEK has a wide gap between the BN layer and the BN layer to fail to form the heat transfer path.

In case of the thermal conductivity in the plane direction, the 5PEEK specimen has a thick filler layer per layer formed by gathering a number of the fillers to form a strong heat transfer path, resulting in excellent thermal conductivity. However, the 1PEEK layer forms a weak heat transfer path due to a thin filler layer per layer, resulting in a little increase in thermal conductivity.

TABLE 2

| | Thermal conductivity | Thermal conductivity |
|---|---|---|
| | in thickness | in plane |
| Sample | direction(W/mK) | direction(W/mK) |
| Comparative Example | 0.258 | 0.267 |
| 1 (PEEK) | | |
| Example 1 (1PEEK/BN) | 0.288 | 0.694 |
| Example 2 (2PEEK/BN) | 0.280 | 0.842 |
| Example 3 (3PEEK/BN) | 0.267 | 1.090 |
| Example 4 (5PEEK/BN) | 0.268 | 1.432 |

### Experimental Example 4—Thermal Conductivity Characteristics 2

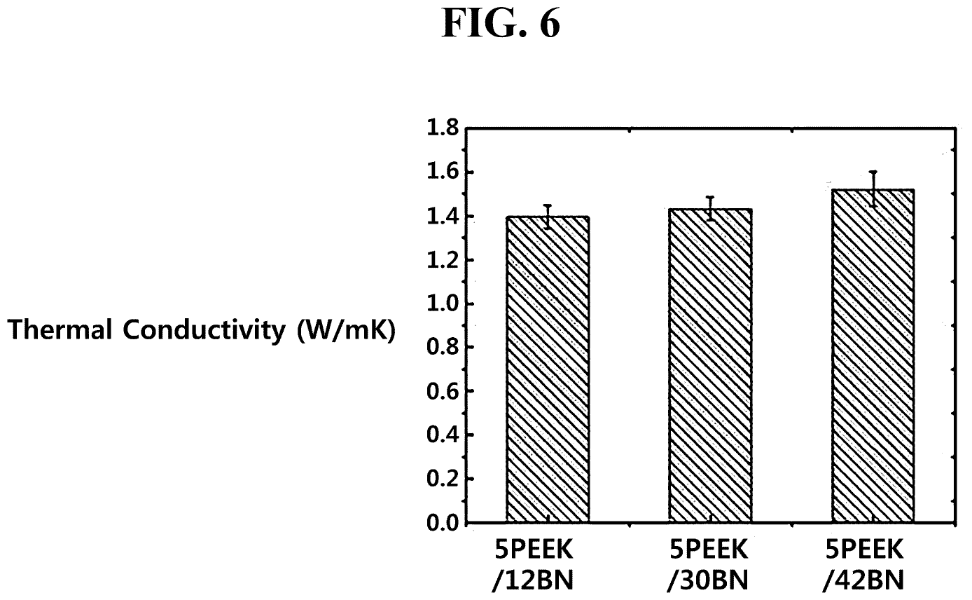

As shown in FIG. 6, the thermal conductivity in a plane direction was observed according to sizes of the boron nitride powders. The experiment was performed in the same manner as that of Experimental Example 3.

The sizes of the BN powders used were 12, 30, and 42 microns. The produced composite material is named XPEEK/YBN, wherein X is the number of repeated PEEK films and Y is the sizes of the BN powders used.

As a result of the observation, it was confirmed that the thermal conductivities of the 5PEEK/12BN, 5PEEK/30BN, and 5PEEK/42BN composite materials were 1.394, 1.432, and 1.522 W/mK, respectively, and that, in particular, the thermal conductivity of the 5PEEK/42BN composite material was enhanced by approximately 471% compared to the PEEK. That is, it was confirmed that the PEEK/BN composite material showed enhanced thermal conductivity in the plane direction as a size of BN (boron nitride) powders increased in the laminated structure of the 5PEEK/BN.

Examples of the present disclosure described above should not be construed to limit the technical idea of the present disclosure. The protection scope of the present disclosure is limited only by the matters described in the claims, and a person who has an ordinary knowledge in the technical field of the present disclosure can improve and change the technical idea of the present disclosure in various forms. Therefore, such improvements and changes will fall within the protection scope of the present disclosure as long as they are obvious to the person who has an ordinary knowledge.

### STATEMENT REGARDING PRIOR DISCLOSURE BY THE INVENTOR OR A JOINT INVENTOR

The second inventor (OH, Yuna) of the present application has made the following related disclosure: “Thermal Property Analysis of a Boron Nitride and their Nanocomposites using Molecular Dynamics Simulations with New Dreiding Force Field,” Doctoral Dissertation, The Graduate School Jeonbuk National University, Aug. 22, 2023. The related disclosure was made less than one year before the effective filing date (Jul. 24, 2024) of the present application. Accordingly, the related disclosure is grace period inventor disclosure, and thus is disqualified from prior art under 35 U.S.C § 102(a)(1) against the present application. See 35 U.S.C § 102(b)(1)(A).

What is claimed is:

1. A nanosheet-reinforced composite material comprising:
a film layer comprising a polyketone-based polymer; and
a filler layer comprising boron nitride,
wherein the film layer and the filler layer are repeatedly laminated on each other.

2. The nanosheet-reinforced composite material according to claim 1,
wherein the film layer is laminated with 1 to 10 films comprising the polyketone-based polymer.

3. The nanosheet-reinforced composite material according to claim 1,
wherein a content of the boron nitride is 1 to 20 wt % based on the total weight of the nanosheet-reinforced composite material.

4. The nanosheet-reinforced composite material according to claim 1,
wherein the nanosheet-reinforced composite material is pressurized and heated by a hot press.

5. The nanosheet-reinforced composite material according to claim 1,
wherein the boron nitride in the filler layer is arranged in a plane direction.

6. The nanosheet-reinforced composite material according to claim 1,
wherein thermal conductivity of the nanosheet-reinforced composite material in a thickness direction is 0.26 W/mK or more.

7. The nanosheet-reinforced composite material according to claim 1,
wherein thermal conductivity of the nanosheet-reinforced composite material in a plane direction is 0.27 W/mK or more.

8. The nanosheet-reinforced composite material according to claim 1,
wherein a tensile strength of the nanosheet-reinforced composite material is 100 MPa or more.

9. The nanosheet-reinforced composite material according to claim 1,
wherein a tensile elastic modulus of the nanosheet-reinforced composite material is 4.3 GPa or more.

10. The nanosheet-reinforced composite material according to claim 1,
wherein the boron nitride is a powder having a particle size of 10 to 45 microns.

11. A method for producing the nanosheet-reinforced composite material of claim 1,
the method comprising the steps of:
preparing a film comprising a polyketone-based polymer;
forming a filler layer by applying boron nitride on the film comprising the polyketone-based polymer; and
obtaining a sheet consisting of multiple layers by repeating the above steps.

12. The method for producing the nanosheet-reinforced composite material, according to claim 11,
wherein the step of preparing the film includes laminating 1 to 10 films comprising the polyketone-based polymer.

13. The method for producing the nanosheet-reinforced composite material, according to claim 11,
wherein the boron nitride is in the form of a powder.

14. The method for producing the nanosheet-reinforced composite material, according to claim 11,
wherein the boron nitride is a powder having a particle size of 10 to 45 microns.

15. The method for producing the nanosheet-reinforced composite material, according to claim 11,
wherein a content of the boron nitride is 1 to 20 wt % based on the total weight of the nanosheet-reinforced composite material.

16. The method for producing the nanosheet-reinforced composite material, according to claim 11,
further comprising the step of pressurizing and heating the sheet.

17. The method for producing the nanosheet-reinforced composite material, according to claim 16,
wherein the pressurizing is performed at 5 to 15 MPa.

18. The method for producing the nanosheet-reinforced composite material, according to claim 16,
wherein the heating is performed at 350 to 450° C.

19. The method for producing the nanosheet-reinforced composite material, according to claim 16,
further comprising the step of cooling the sheet after the pressurizing and heating.

20. The method for producing the nanosheet-reinforced composite material, according to claim 19,
wherein the cooling is performed at 200 to 300° C.
